(19) United States
(12) Patent Application Publication
(10) Pub. No.: US 2022/0098425 A1
(43) Pub. Date: Mar. 31, 2022

(54) CONTINUOUS INK SUPPLY SYSTEM

(71) Applicant: Hewlett-Packard Development Company, L.P., Spring, TX (US)

(72) Inventors: Vladimir Jakubek, Corvallis, OR (US); Richard J. McManus, Corvallis, OR (US); Carrie E. Harris, Corvallis, OR (US)

(73) Assignee: Hewlett-Packard Development Company, L.P., Spring, TX (US)

(21) Appl. No.: 17/417,435

(22) PCT Filed: Feb. 22, 2019
(86) PCT No.: PCT/US2019/019170

§ 371 Date: Jun. 23, 2021

(51) Int. Cl. C09D 11/324; C09D 11/037; B41J 2/175

(52) U.S. Cl. CPC C09D 11/324; B41J 2/17503; C09D 11/037

(57) ABSTRACT

An example of a continuous ink supply system includes an ink supply reservoir, a conduit fluidly connected to the ink supply reservoir, and a low-conductivity ink contained in the ink supply reservoir. The low-conductivity ink includes a self-dispersed carbon black pigment, a non-ionic surfactant, a co-solvent, and a balance of water. The low-conductivity ink has a conductivity of 400 or less μS/cm.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a semi-schematic perspective view of an example of a continuous ink supply system;

FIG. 2 is a schematic illustration of an example of a printing system;

FIG. 3 is a schematic illustration of a printing system with an example of a continuous ink supply system that includes a feeder tank;

FIG. 4 is a schematic side view of an example ink tank of a continuous ink supply system;

FIG. 5 is a schematic side view of the ink tank of FIG. 4 shown from the opposite side, with a portion of the side removed to illustrate some of the interior components of the ink tank;

FIGS. 6A through 6C are cut-away, cross-sectional views of an example cap assembly of the ink tank of FIGS. 4 and 5 in a closed position (FIG. 6A), a partially opened position (FIG. 6B), and a fully opened position (FIG. 6C);

FIG. 7 is a schematic and cross-sectional view of an example of a valve integrated into a print cartridge;

FIG. 8 is a semi-schematic perspective view of another example of a valve that can be inserted into a print cartridge;

FIGS. 9A and 9B are cross-sectional views of the valve and a portion of the print cartridge shown in FIG. 8;

FIGS. 10A through 10C depict black and white reproductions of originally colored photographs of highlighter smear tests of a print generated with an example of the binder-less, low-conductivity ink (FIG. 10A) and prints generated with comparative inks (FIGS. 10B and 10C);

FIG. 11 is a graph showing viscosity as a function of percentage of water depletion for the example of the binder-less, low-conductivity ink (Ex. Ink) and the comparative inks (Comp. Ink 1 and Comp. Ink 2), with the viscosity (in cP) shown on the Y-axis, and the percentage (by weight) of water depletion shown on the X-axis;

FIG. 12 is a graph showing recovery level as a function of time spun for the example of the binder-less, low-conductivity ink (Ex. Ink) and one of the comparative inks (Comp. Ink 2), with the recovery level shown on the Y-axis, and the time spun (in hours) shown on the X-axis; and

FIG. 13 is a graph showing the effect of the example of the binder-less, low-conductivity ink (Ex. Ink) and one of the comparative inks (Comp. Ink 2) on pen reliability as function of time, with the reliability (in N/mm² as the unit for adhesion strength) shown on the Y-axis, and the time (in weeks) shown on the X-axis.

### DETAILED DESCRIPTION

Continuous ink supply systems (often referred to as CISS) may be used to deliver a large volume of ink (e.g., up to 5 liters) to a comparatively small inkjet printhead. As such, continuous ink supply systems may enable tens of thousands of prints to be generated before the ink supply is replaced. However, using a continuous ink supply system can present challenges, in part because of the large volume of ink stored and printed with a single inkjet printhead. For example, the ink in an ink supply reservoir of a continuous ink supply system may, in some instances, settle. Ink settling may result in poor print quality. As another example, the ink in a continuous ink supply system may, in some instances, cause caking on a die of the inkjet printhead. Caking may cause missing nozzles (i.e., ink cannot eject from the printhead), which may also result in poor print quality. As still another example, the ink in a continuous ink supply system may, in some instances, cause electrical shorts in the inkjet printhead. Electrical shorts may cause the inkjet printhead to stop working.

Disclosed herein are a low-conductivity inkjet ink, and in some examples, a binder-less, low-conductivity inkjet ink, that are suitable for use with a continuous ink supply system. The low-conductivity inks disclosed herein are also suitable for use in individual printhead applicators, such as consumable inkjet ink cartridges.

An example of low-conductivity inkjet ink or an example of the binder-less, low-conductivity inkjet ink comprises: a self-dispersed carbon black pigment; a non-ionic surfactant; a co-solvent; and a balance of water; wherein the ink has a conductivity of 400 μS/cm or less. Another example of the low-conductivity inkjet ink or the binder-less, low-conductivity inkjet ink consists of: a self-dispersed carbon black pigment; a non-ionic surfactant; a co-solvent; an additive selected from the group consisting of a chelating agent, an antimicrobial agent, an anti-kogation agent, an anti-decel agent, a pH adjuster, a buffering agent, and a combination thereof; and a balance of water; wherein the ink has a conductivity of 400 μS/cm or less. It has been found that when the low-conductivity inks disclosed herein are used with a continuous ink supply system, the low-conductivity inks have reduced ink settling and do not cause caking or electrical shorts. As such, the low-conductivity inks, including the binder-less, low-conductivity ink disclosed herein, may be particularly suitable for use in a continuous ink supply system. Attributes of the low-conductivity inks, including reduced ink settling, are also desirable for consumable inkjet ink cartridges, and thus the inks may be suitable for use in traditional inkjet printing systems. With both types of printing systems, the inks are capable of generating prints with improved durability.

Throughout this disclosure, a weight percentage that is referred to as “wt % active” refers to the loading of an active component of a dispersion or other formulation that is present in the low-conductivity ink. For example, the self-dispersed carbon black pigment may be present in a water-based formulation (e.g., a stock solution or dispersion) before being incorporated into the low-conductivity ink. In this example, the wt % actives of the self-dispersed carbon black pigment accounts for the loading (as a weight percent) of the self-dispersed carbon black pigment that is present in the low-conductivity ink, and does not account for the weight of the other components (e.g., water, etc.) that are present in the formulation with the self-dispersed carbon black pigment. The term “wt %,” without the term actives, refers to either i) the loading (in the low-conductivity ink) of a 100% active component that does not include other non-active components therein, or the loading (in the low-conductivity ink) of a material or component that is used “as is” and thus the wt % accounts for both active and non-active components.

The low-conductivity ink will now be described.

Low-Conductivity Inkjet Inks

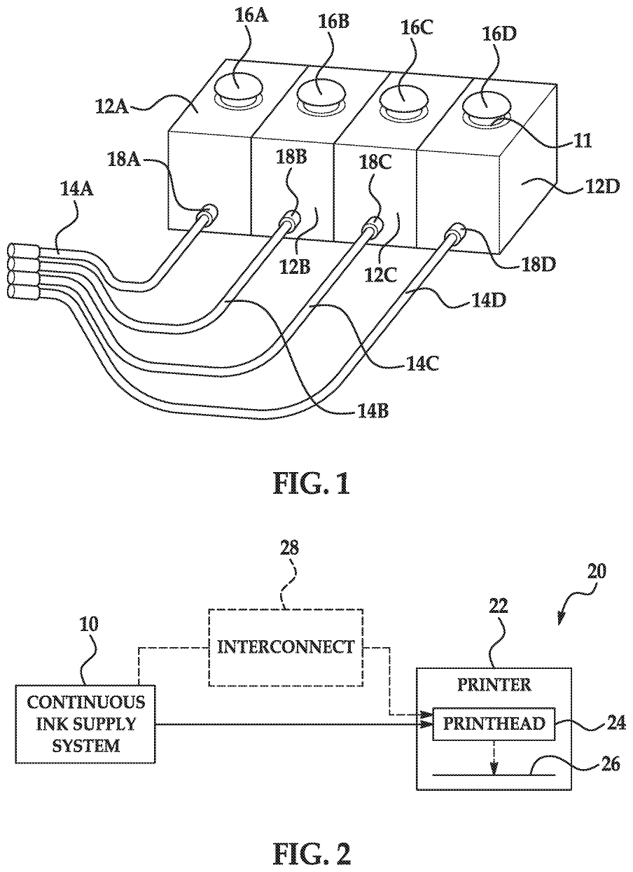

Examples of the low-conductivity inkjet ink disclosed herein may be used in a continuous ink supply system (examples of which are discussed further in reference to FIG. 1 through FIG. 9B). While the discussion presented herein relates to a continuous ink supply system, it is to be understood that the low-conductivity ink disclosed herein may also be used in individual ink cartridges, pens, or other individual applicators that include thermal or piezoelectric printheads. Regardless of the printing system used, examples of the low-conductivity ink disclosed herein may generate prints with good print quality and durability.

Examples of the low-conductivity ink include a self-dispersed carbon black pigment, a non-ionic surfactant, a co-solvent, and a balance of water. In some examples, the low-conductivity ink may consist of the self-dispersed carbon black pigment, the non-ionic surfactant, the co-solvent, and the balance of water with no other components. In other examples, the low-conductivity ink may include additional components, such as additives that do not increase the conductivity of the ink. In some of these examples, the low-conductivity ink (or the binder-less, low-conductivity ink) further comprises an additive selected from the group consisting of a chelating agent, an antimicrobial agent, an anti-kogation agent, an anti-decel agent, a pH adjuster, a buffering agent, and a combination thereof. In still other examples, the low-conductivity ink may consist of the self-dispersed carbon black pigment, the non-ionic surfactant, the co-solvent, water, and an additive selected from the group consisting of a chelating agent, an antimicrobial agent, an anti-kogation agent, an anti-decel agent, a pH adjuster, a buffering agent, and combination thereof.

In some examples, the low-conductivity ink is binder-less or is devoid of a binder. As used herein, the terms “binder-less” and “devoid of a binder” mean, in some instances, that the ink does not include any binder, such as a polymeric binder, or any other polymeric dispersant that may also function as a binder. In other instances, the terms “binder-less” and “devoid of a binder” may mean that the ink composition does not include any added amount of the binder, but may contain residual amounts, such as in the form of impurities from other components and/or from a processing technique. The binder may be present in trace amounts, and in one aspect, in an amount of less than 0.05 weight percent (wt % or wt % active) based on the total weight of the composition (e.g., the low-conductivity ink), even though the composition is described as being “devoid of” the binder. In other words, the binder is not specifically included, but may be present in trace amounts or as an impurity inherently present in certain ingredients.

The low-conductivity ink has a conductivity of 400 μS/cm or less. As such, the term “low-conductivity” refers to the conductivity of the ink, where the conductivity is 400 μS/cm or less. In an example, the conductivity ranges from about 50 μS/cm up to 400 μS/cm. In some examples, the low-conductivity ink has a conductivity of 300 μS/cm or less. In other examples, the low-conductivity ink has a conductivity ranging from about 50 μS/cm to about 300 μS/cm. In still other examples, the low-conductivity ink has a conductivity of about 148 μS/cm.

In some examples, the low-conductivity ink has a viscosity ranging from about 2.4 cP to about 2.9 cP at 25° C. In one of these examples, the low-conductivity ink has a viscosity of about 2.7 cP at 25° C. As such, examples of the low-conductivity ink disclosed herein may be used in a thermal inkjet printer or in a piezoelectric inkjet printer. The viscosity of the low-conductivity ink may be adjusted for the type of printhead that is to be used, and the viscosity may be adjusted by adjusting the co-solvent level and/or adding a viscosity modifier. When used in a thermal inkjet printer, the viscosity of the low-conductivity ink may be modified to range from about 1 cP to about 10 cP (at a temperature ranging from 20° C. to 25° C.), and when used in a piezoelectric printer, the viscosity of the low-conductivity ink may be modified to range from about 2 cP to about 20 cP (at a temperature ranging from 20° C. to 25° C.), depending on the type of the printhead that is being used (e.g., low viscosity printheads, medium viscosity printheads, or high viscosity printheads).

Self-Dispersed Carbon Black Pigment

The self-dispersed carbon black pigment may be incorporated into the low-conductivity ink as a pigment dispersion. For the pigment dispersions disclosed herein, it is to be understood that the self-dispersed carbon black pigment (prior to being incorporated into the ink formulation) may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butanediol, diethylene glycol, triethylene glycol, tetraethylene glycol, or a combination thereof. It is to be understood however, that the liquid components of the pigment dispersion become part of the aqueous vehicle in the low-conductivity ink.

In some examples, the self-dispersed carbon black pigment is present in the low-conductivity ink in an amount ranging from about 2.5 wt % active to about 10 wt % active, based on a total weight of the low-conductivity ink. In one of these examples, the self-dispersed carbon black pigment is present in an amount of about 3.75 wt % active.

In some examples, the self-dispersed carbon black pigment has an average particle size ranging from about 115 nm to about 145 nm. In other examples, the self-dispersed carbon black pigment has an average particle size ranging from about 120 nm to about 140 nm or from about 125 nm to about 145 nm. The average particle size may be the volume-weighted mean diameter of a distribution of particles. The average particle size may be presented in terms of D50, or the median of the particle size distribution, where ½ the population is above this value and ½ is below this value. The average particle size may also be presented in terms of D10, where 10% of the population is below the D10 value, or in terms of D90, where 90% of the population is below the D90 value. In one specific example, the volume-weighted mean diameter (Mv) of the self-dispersed carbon black pigment is about 129 nm. In yet another specific example, the D50 value of the self-dispersed carbon black pigment distribution is about 123 nm (e.g., determined using the volume of the particles).

The average particle size of any solids in the example inks, including the average particle size of the self-dispersed carbon black pigment, can be determined using a NANOTRAC® Wave device, from Microtrac, e.g., NANOTRAC® Wave II or NANOTRAC® 150, etc., which measures the particle size using dynamic light scattering. The average particle size can be determined using particle size distribution data (e.g., based on particle volume) generated by the NANOTRAC® Wave device.

Examples of carbon black pigments that may be used in the self-dispersed carbon black pigment include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation, Boston, Mass., (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various carbon black pigments manufactured by Evonik Degussa Orion Corporation, Parsippany, N.J., (such as, e.g., Color Black FW1, Color Black FW2, Color Black FW2V, Color Black FW18, Color Black FW200, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4).

As used herein, the term “self-dispersing pigment” refers to a pigment having water-solubilizing groups on the pigment surface. The self-dispersing pigment can be dispersed in water without an additional polymer dispersant. In an example, the self-dispersing pigment is obtained by carrying out surface modification treatments, such as an acid/base treatment, a coupling agent treatment, a polymer graft treatment, a plasma treatment, an oxidation/reduction treatment, an ozone and light (e.g., light and ultra-violet radiation) treatment, on a carbon black pigment. In one specific example, the surface of the carbon black pigment may be modified by exposure to ozone and light to form oxidized groups on the carbon black pigment.

Examples of the self-dispersed carbon black dispersions are commercially available from E.I. du Pont de Nemours and Co. (Wilmington, Del.).

In some examples, the self-dispersed carbon black pigment has a water-solubilizing organic group attached thereto. The water-solubilizing organic group that is attached to the carbon black pigment includes at least one aromatic group, an alkyl (e.g., C₁ to C₂₀), and an ionic or ionizable group.

The aromatic group may be an unsaturated cyclic hydrocarbon containing one or more rings and may be substituted or unsubstituted, for example with alkyl groups. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like).

The alkyl may be branched or unbranched, substituted or unsubstituted.

The ionic or ionizable group may be at least one phosphorus-containing group, at least one sulfur-containing group, or at least one carboxylic acid group.

In an example, the at least one phosphorus-containing group has at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof. By “partial ester thereof”, it is meant that the phosphorus-containing group may be a partial phosphonic acid ester group having the formula —PO₃RH, or a salt thereof, wherein R is an aryl, alkaryl, aralkyl, or alkyl group. By “salts thereof”, it is meant that the phosphorus-containing group may be in a partially or fully ionized form having a cationic counterion.

When the organic group includes at least two phosphonic acid groups or salts thereof, either or both of the phosphonic acid groups may be a partial phosphonic ester group. Also, one of the phosphonic acid groups may be a phosphonic acid ester having the formula —PO₃R₂, while the other phosphonic acid group may be a partial phosphonic ester group, a phosphonic acid group, or a salt thereof. In some instances, it may be desirable that at least one of the phosphonic acid groups is either a phosphonic acid, a partial ester thereof, or salts thereof. When the organic group includes at least two phosphonic acid groups, either or both of the phosphonic acid groups may be in either a partially or fully ionized form. In these examples, either or both may of the phosphonic acid groups have the formula —PO₃H₂, —PO₃H⁻M⁺ (monobasic salt), or —PO₃⁻² M⁺² (dibasic salt), wherein M⁺ is a cation such as Na⁺, K⁺, Li⁺, or NR₄⁺, wherein R, which can be the same or different, represents hydrogen or an organic group such as a substituted or unsubstituted aryl and/or alkyl group.

As other examples, the organic group may include at least one geminal bisphosphonic acid group, partial esters thereof, or salts thereof. By “geminal”, it is meant that the at least two phosphonic acid groups, partial esters thereof, or salts thereof are directly bonded to the same carbon atom. Such a group may also be referred to as a 1,1-diphosphonic acid group, partial ester thereof, or salt thereof.

An example of a geminal bisphosphonic acid group may have the formula —CQ(PO₃H₂)₂, or may be partial esters thereof or salts thereof. Q is bonded to the geminal position and may be H, R, OR, SR, or NR₂ wherein R, which can be the same or different when multiple are present, is selected from H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. For examples, Q may be H, R, OR, SR, or NR₂, wherein R, which can be the same or different when multiple are present, is selected from H, a C₁-C₆ alkyl group, or an aryl group. As specific examples, Q is H, OH, or NH₂. Another example of a geminal bisphosphonic acid group may have the formula —(CH₂)ₙCQ(PO₃H₂)₂, or may be partial esters thereof or salts thereof, wherein Q is as described above and n is 0 to 9, such as 1 to 9. In some specific examples, n is 0 to 3, such as 1 to 3, or n is either 0 or 1.

Still another example of a geminal bisphosphonic acid group may have the formula —X—(CH₂)ₙCQ(PO₃H₂)₂, or may be partial esters thereof or salts thereof, wherein Q and n are as described above and X is an arylene, heteroarylene, alkylene, vinylidene, alkarylene, aralkylene, cyclic, or heterocyclic group. In specific examples, X is an arylene group, such as a phenylene, naphthalene, or biphenylene group, which may be further substituted with any group, such as one or more alkyl groups or aryl groups. When X is an alkylene group, examples include substituted or unsubstituted alkylene groups, which may be branched or unbranched and can be substituted with one or more groups, such as aromatic groups. Examples of X include C₁-C₁₂ groups like methylene, ethylene, propylene, or butylene. X may be directly attached to the carbon black pigment, meaning there are no additional atoms or groups from the attached organic group between the carbon black pigment and X. X may also be further substituted with one or more functional groups. Examples of functional groups include R′, OR′, COR′, COOR′, OCOR′, carboxylates, halogens, CN, NR′₂, SO₃H, sulfonates, sulfates, NR′(COR′), CONR′₂, imides, NO₂, phosphates, phosphonates, N═NR′, SOR′, NR′SO₂R′, and SO₂NR′₂, wherein R′, which can be the same or different when multiple are present, is independently selected from hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

Yet another example of a geminal bisphosphonic acid group may have the formula —X-Sp-(CH₂)ₙCQ(PO₃H₂)₂, or may be partial esters thereof or salt thereof, wherein X, Q, and n are as described above. “Sp” is a spacer group, which, as used herein, is a link between two groups. Sp can be a bond or a chemical group. Examples of chemical groups include, but are not limited to, —CO₂—, —O₂C—, —CO—, —OSO₂—, —SO₃—, —SO₂—, —SO₂C₂H₄O—, —SO₂C₂H₄S—, —SO₂C₂H₄NR″—, —O—, —S—, —NR″—, —NR″CO—, —CONR″—, —NR″CO₂—, —O₂CNR″—, —NR″CONR″—, —N(COR″)CO—, —CON(COR″)—, —NR″COCH(CH₂CO₂R″)— and cyclic imides therefrom, —NR″COCH₂CH(CO₂R″)— and cyclic imides therefrom, —CH(CH₂CO₂R″)CONR″— and cyclic imides therefrom, —CH(CO₂R″)CH₂CONR″ and cyclic imides therefrom (including phthalimide and maleimides of these), sulfonamide groups (including —SO₂NR″— and —NR″SO₂— groups), arylene groups, alkylene groups and the like. R″, which can be the same or different when multiple are included, represents H or an organic group such as a substituted or unsubstituted aryl or alkyl group. In the example formula —X-Sp-(CH₂)ₙCQ(PO₃H₂)₂, the two phosphonic acid groups or partial esters or salts thereof are bonded to X through the spacer group Sp. Sp may be —CO₂—, —O₂C—, —O—, —NR″—, —NR″CO—, or —CONR″—, —SO₂NR″—, —SO₂CH₂CH₂NR″—, —SO₂CH₂CH₂O—, or —SO₂CH₂CH₂S— wherein R″ is H or a C₁-C₆ alkyl group.

Still a further example of a geminal bisphosphonic acid group may have the formula —N—[(CH₂)ₘ(PO₃H₂)]₂, partial esters thereof, or salts thereof, wherein m, which can be the same or different, is 1 to 9. In specific examples, m is 1 to 3, or 1 or 2. As another example, the organic group may include at least one group having the formula —(CH₂)n-N—[(CH₂)ₘ(PO₃H₂)]₂, partial esters thereof, or salts thereof, wherein n is 0 to 9, such as 1 to 9, or 0 to 3, such as 1 to 3, and m is as defined above. Also, the organic group may include at least one group having the formula —X—(CH₂)ₙ—N—[(CH₂)ₘ(PO₃H₂)]₂, partial esters thereof, or salts thereof, wherein X, m, and n are as described above, and, in an example, X is an arylene group. Still further, the organic group may include at least one group having the formula —X-Sp-(CH₂)ₙ—N—[(CH₂)ₘ(PO₃H₂)]₂, partial esters thereof, or salts thereof, wherein X, m, n, and Sp are as described above.

Yet a further example of a geminal bisphosphonic acid group may have the formula —CR═C(PO₃H₂)₂, partial esters thereof, or salts thereof. In this example, R can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In an example, R is H, a C₁-C₆ alkyl group, or an aryl group.

The organic group may also include more than two phosphonic acid groups, partial esters thereof, or salts thereof, and may, for example include more than one type of group (such as two or more) in which each type of group includes at least two phosphonic acid groups, partial esters thereof, or salts thereof. For example, the organic group may include a group having the formula —X—[CQ(PO₃H₂)₂]_{P}, partial esters thereof, or salts thereof. In this example, X and Q are as described above. In this formula, p is 1 to 4, e.g., 2.

In addition, the organic group may include at least one vicinal bisphosphonic acid group, partial ester thereof, or salts thereof, meaning that these groups are adjacent to each other. Thus, the organic group may include two phosphonic acid groups, partial esters thereof, or salts thereof bonded to adjacent or neighboring carbon atoms. Such groups are also sometimes referred to as 1,2-diphosphonic acid groups, partial esters thereof, or salts thereof. The organic group including the two phosphonic acid groups, partial esters thereof, or salts thereof may be an aromatic group or an alkyl group, and therefore the vicinal bisphosphonic acid group may be a vicinal alkyl or a vicinal aryl diphosphonic acid group, partial ester thereof, or salts thereof. For example, the organic group may be a group having the formula —C₆H₃—(PO₃H₂)₂, partial esters thereof, or salts thereof, wherein the acid, ester, or salt groups are in positions ortho to each other.

In other examples, the ionic or ionizable group (of the organic group attached to the carbon black pigment) is a sulfur-containing group. The at least one sulfur-containing group has at least one S═O bond, such as a sulfinic acid group or a sulfonic acid group. Salts of sulfinic or sulfonic acids may also be used, such as —SO₃⁻X⁺, where X is a cation, such as Na⁺, H⁺, K⁺, NH₄⁺, Li⁺, Ca²⁺, Mg⁺, etc.

When the ionic or ionizable group is a carboxylic acid group, the group may be COOH or a salt thereof, such as —COO⁻X⁺, —(COO⁻X⁺)₂, or —(COO⁻X⁺)₃.

Examples of the self-dispersed carbon black pigments are commercially available as dispersions. Suitable commercially available self-dispersed carbon black pigment dispersions include CAB-O-JET® 200, CAB-O-JET® 400, CAB-O-JET® 300, and CAB-O-JET® 352K, each of which is manufactured by Cabot Corporation.

Still other examples of the self-dispersed carbon black colorant include polymer dispersed carbon black pigments commercially available from Sensient Technologies Corporation.

Aqueous Vehicles

As mentioned above, the low-conductivity inkjet ink includes a non-ionic surfactant, a co-solvent, and a balance of water, in addition to the self-dispersed carbon black pigment. The non-ionic surfactant, co-solvent, and water may be part of an aqueous vehicle. As used herein, the term “aqueous vehicle” may refer to the liquid fluid in which the self-dispersed carbon black pigment is mixed to form the low-conductivity inkjet ink.

In an example of the low-conductivity ink, the aqueous vehicle includes the non-ionic surfactant, the co-solvent, and a balance of water.

Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the aqueous vehicle may include a silicone-free alkoxylated alcohol surfactant such as, for example, TECO® Wet 510 (Evonik Industries) and/or a self-emulsifiable wetting agent based on acetylenic diol chemistry, such as, for example, SURFYNOL® SE-F (Evonik Industries). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Industries); ZONYL® FSN, ZONYL® FSO, ZONYL® FSH, and CAPSTONE® FS-35 (each of which is a water-soluble, ethoxylated non-ionic fluorosurfactant manufactured by The Chemours Company); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.); and BYK® 345, BYK® 346, BYK® 347, BYK® 348, BYK® 349 (each of which is a silicone surfactant) (all of which are available from BYK Chemie).

In some examples, the non-ionic surfactant is present in the low-conductivity ink in an amount ranging from about 0.01 wt % active to about 0.5 wt % active, based on a total weight of the low-conductivity ink. In one of these examples, the total amount of the non-ionic surfactant(s) may be present in the low-conductivity ink in an amount ranging from about 0.01 wt % active to about 3 wt % active, based on the total weight of the low-conductivity ink. In another of these examples, the total amount of the non-ionic surfactant(s) may be present in the low-conductivity ink in an amount of about 0.1 wt % active, based on the total weight of the low-conductivity ink.

The low-conductivity inkjet ink also includes a co-solvent. Examples of suitable co-solvents include alcohols, aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl alcohol, butyl alcohol, and benzyl alcohol. The co-solvent may also be a polyhydric alcohol or a polyhydric alcohol derivative. Examples of polyhydric alcohols may include ethylene glycol, diethylene glycol, propylene glycol, dipropylene glycol, butylene glycol, triethylene glycol, 1,5-pentanediol, 1,2-hexanediol, 1,2,6-hexanetriol, 1,2-butanediol, 1,2-propanediol, 1,3-propanediol, glycerin (glycerol), trimethylolpropane, and xylitol. Examples of polyhydric alcohol derivatives may include an ethylene oxide adduct of diglycerin. The co-solvent may also be a nitrogen-containing solvent. Examples of nitrogen-containing solvents may include 2-pyrrolidone, 1-(2-hydroxyethyl)-2-pyrrolidone, Di-(2-Hydroxyethyl)-5, 5-Dimethylhydantoin (DANTOCOL® DHE from Lonza), N-methyl-2-pyrrolidone, cyclohexylpyrrolidone, and triethanolamine. In one specific example, the co-solvent includes a combination of two solvents, such as 2-pyrrolidone and 1,5-pentanediol.

In some examples, the co-solvent(s) is/are present in the low-conductivity ink in an amount ranging from about 5 wt % to about 35 wt %, based on a total weight of the low-conductivity ink. In other examples, the total amount of the co-solvent(s) that may be present in the low-conductivity ink ranges from about 10 wt % to about 20 wt %, or from about 5 wt % to about 15 wt %, or from about 20 wt % to about 35 wt %, based on the total weight of the low-conductivity ink. In still other examples, the total amount of the co-solvent(s) in the low-conductivity ink may be about 7 wt %, about 9 wt %, or about 13 wt % based on the total weight of the low-conductivity ink.

It is to be understood that water is present in addition to the non-ionic surfactant(s) and co-solvent(s). The water may be purified water or deionized water, and makes up a balance of the low-conductivity ink. As such, the weight percentage of the water present in the low-conductivity ink will depend, in part, upon the weight percentages of the other components. Further, it is to be understood that the water included in the low-conductivity ink may be: i) part of the self-dispersed carbon black pigment dispersion, ii) part of the aqueous vehicle, iii) added to a mixture of the self-dispersed carbon black pigment dispersion and the aqueous vehicle, or iv) a combination thereof.

An example of the aqueous vehicle further includes an additive selected from the group consisting of a chelating agent, an antimicrobial agent, an anti-kogation agent, an anti-decel agent, a pH adjuster, a buffering agent, and a combination thereof. It is to be understood that these additives may or may not be included in the low-conductivity ink. It is further to be understood that, when included in the low-conductivity ink, the additive(s) and the amounts thereof are to be selected so that the conductivity of the low-conductivity ink is 400 μS/cm or less.

Some examples of the low-conductivity inkjet ink further include a chelating agent. When included, the chelating agent may be present in an amount greater than 0 wt % active and less than or equal to 0.5 wt % active, based on the total weight of the low-conductivity ink. In an example, the chelating agent is present in an amount ranging from about 0.05 wt % active to about 0.2 wt % active, based on the total weight of the low-conductivity ink.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Antimicrobial agents are another example of an additive that may be included in the low-conductivity ink. Antimicrobial agents are also known as biocides and/or fungicides. When included, the total amount of antimicrobial agent(s) in the low-conductivity ink may range from about 0.001 wt % active to about 0.1 wt % active (based on the total weight of the low-conductivity ink). In an example, the total amount of antimicrobial agent(s) in the low-conductivity ink ranges from about 0.001 wt % active to about 0.05 wt % active (based on the total weight of the low-conductivity ink). In another example, the total amount of antimicrobial agent(s) in the low-conductivity ink is about 0.044 wt % active (based on the total weight of the low-conductivity ink).

Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Co.), and combinations thereof.

An anti-kogation agent may also be included in a low-conductivity ink that is to be thermal inkjet printed. Kogation refers to the deposit of dried printing liquid on a heating element of a thermal inkjet printhead. Anti-kogation agent(s) is/are included to assist in preventing the buildup of kogation. In some examples, the anti-kogation agent may improve the jettability of the low-conductivity ink. When included, the anti-kogation agent may be present in the low-conductivity ink in an amount ranging from about 0.1 wt % active to about 1.5 wt % active, based on the total weight of the low-conductivity ink. In an example, the anti-kogation agent is present in an amount of about 0.5 wt % active, based on the total weight of the low-conductivity ink.

Examples of suitable anti-kogation agents include oleth-3-phosphate (commercially available as CRODAFOS™ O3A or CRODAFOS™ N-3A) or dextran 500 k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

Anti-decel agents are another example of an additive that may be included in the low-conductivity inkjet ink. The anti-decel agent may function as a humectant. Decel refers to a decrease in drop velocity over time with continuous firing. In the examples disclosed herein, the anti-decel agent (s) is/are included to assist in preventing decel. In some examples, the anti-decel agent may improve the jettability of the low-conductivity ink. When included, the anti-decel agent(s) may be present in an amount ranging from about 0.2 wt % active to about 12 wt % active (based on the total weight of the low-conductivity ink). In an example, the anti-decel agent is present in the low-conductivity ink in an amount of about 4.8 wt % active, based on the total weight of the low-conductivity ink.

An example of a suitable anti-decel agent is ethoxylated glycerin having the following formula:

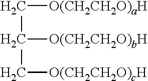

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

A pH adjuster may also be included in the low-conductivity ink. A pH adjuster may be included in the low-conductivity ink to achieve a desired pH (e.g., 6.8) and/or to counteract any slight pH drop that may occur over time. When included, the total amount of pH adjuster(s) in the low-conductivity ink may range from greater than 0 wt % to about 0.1 wt % (based on the total weight of the low-conductivity ink). In another example, the total amount of pH adjuster(s) in the low-conductivity ink about 0.03 wt % (based on the total weight of the low-conductivity ink).

Examples of suitable pH adjusters include metal hydroxide bases, such as potassium hydroxide (KOH), sodium hydroxide (NaOH), etc. In an example, the metal hydroxide base may be added to the low-conductivity ink in an aqueous solution. In another example, the metal hydroxide base may be added to the low-conductivity ink in an aqueous solution including 5 wt % of the metal hydroxide base (e.g., a 5 wt % potassium hydroxide aqueous solution).

A buffering agent may also be added to the low-conductivity ink, in part to counteract any slight pH drop that may occur over time. When included, the total amount of buffering agent(s) in the low-conductivity ink may range from greater than 0 wt % active to about 0.5 wt % active (based on the total weight of the low-conductivity ink). In another example, the total amount of buffering agent(s) in the low-conductivity ink is about 0.1 wt % active (based on the total weight of the low-conductivity ink).

Examples of some suitable buffering agents include TRIS (tris(hydroxymethyl)aminomethane or Trizma), bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), sodium borate, sodium hydrogen phosphate, and sodium dihydrogen phosphate, or the like.

Suitable pH ranges for examples of the low-conductivity inkjet ink can be from pH 6 to pH 11, from pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, from pH 7.5 to pH 8, from pH 6 to pH 8, or from 6.8 to 7.3. In one example, the pH of the low-conductivity ink is pH 7.5.

Continuous Ink Supply Systems

The low-conductivity inkjet ink described herein may be used in a continuous ink supply system. An example of the continuous ink supply system 10 is shown in FIG. 1. The continuous ink supply system 10 includes one or more ink supply reservoirs 12A-12D and respective fluid conduits 14A-14D that are connected to the ink supply reservoirs 12A-12D. The fluid conduits 14A-14D deliver the respective inks or other print fluids contained therein (e.g., the low-conductivity ink) from the reservoirs/tanks 12A-12D to printheads of a printer (not shown in FIG. 1). The continuous ink supply system 10 facilitates replenishment of the low-conductivity ink (or other print fluid) while the printer is performing a printing job or task, e.g., printing a pattern. In particular, the low-conductivity ink may be added to the printheads without halting the print job of the printer.

In an example, the continuous ink supply system 10 comprises: an ink supply reservoir 12A-12D; a conduit 14A-14C fluidly connected to the ink supply reservoir 12A-12D; and a low-conductivity ink contained in the ink supply reservoir 12A-12D, the low-conductivity ink including: a self-dispersed carbon black pigment; a non-ionic surfactant; a co-solvent; and a balance of water; wherein the low-conductivity ink has a conductivity of 400 μS/cm or less.

In another example, the continuous ink supply system 10 comprises: an ink supply reservoir 12A-12D; a conduit 14A-14D fluidly connected to the ink supply reservoir 12A-12D; and a low-conductivity ink contained in the ink supply reservoir 12A-12D, the low-conductivity ink consisting of: a self-dispersed carbon black pigment; a non-ionic surfactant; a co-solvent; an additive selected from the group consisting of a chelating agent, an antimicrobial agent, an anti-kogation agent, an anti-decel agent, a pH adjuster, a buffering agent, and a combination thereof; and a balance of water; wherein the low-conductivity ink has a conductivity of 400 μS/cm or less.

It is to be understood that any example of the low-conductivity ink described herein may be used in examples of the continuous ink supply system 10.

The continuous ink supply system 10 includes the ink supply reservoirs 12A-12D. The example shown in FIG. 1 includes four ink supply reservoirs 12A-12D, which may contain four different colored inks, such as black (e.g., the low-conductivity ink disclosed herein), cyan, magenta, and yellow. It is to be understood that additional or fewer ink supply reservoirs 12A-12D may be used, depending upon the printer with which the continuous ink supply system 10 is used, or of which the continuous ink supply system is a part.

The ink supply reservoir 12A-12D includes a housing having walls to define a cavity. The cavity is not limited and may be any shape designed to store the print fluid during operation of the printer. For example, the ink supply reservoir 12A-12D may have a unique shape to complement a design of the printer. As example, the ink supply reservoir 12A-12D may be substantially cylindrical or rectangular in shape.

In the example shown in FIG. 1, the ink supply reservoir 12A-12D is a refillable container that stores the ink or other print fluid. The container may be plastic, or another suitable material. In this example, the ink supply reservoir 12A-12D includes an inlet port 11 (shown covered by a cap 16A-16D in FIG. 1), through which additional ink or other print fluid may be introduced from an external source, such as a bottle or a larger external tank via tubing, during a filling process.

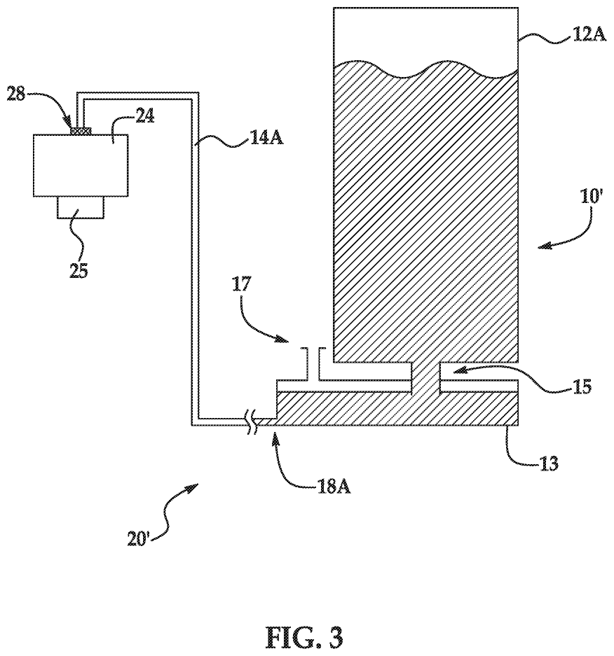

In other examples (see, e.g., FIG. 3), the ink supply reservoir 12A-12D may be a separate consumable that is to be attached to the fluid conduits 14A-14D (e.g., similar to a disposable ink cartridge).

Each example of the ink supply reservoir 12A-12D also includes an outlet 18A-18D, through which ink may be transported out to the printhead.

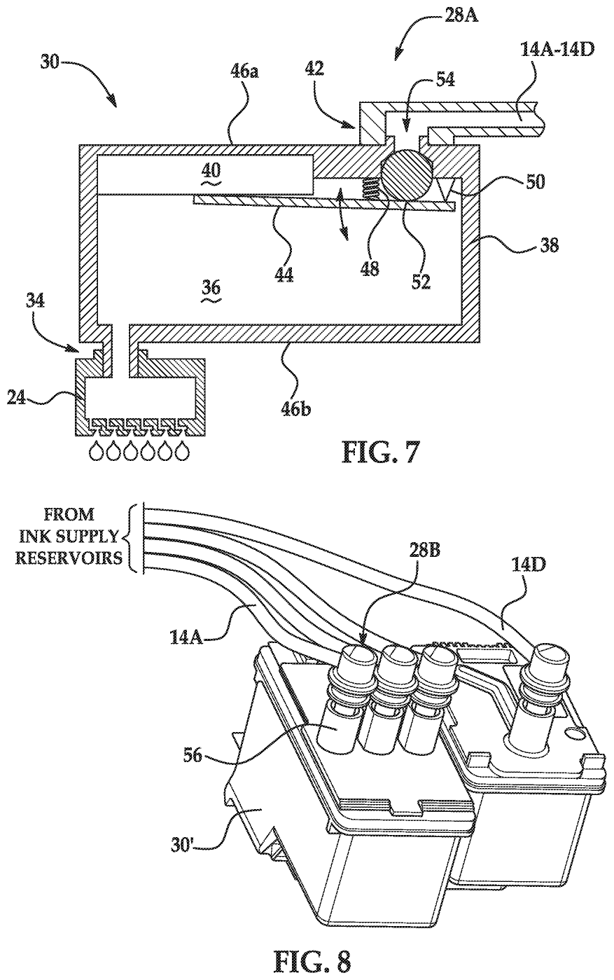

In some examples (described in more detail in reference to FIGS. 3-6), each ink supply reservoir 12A-12D may be used in conjunction with an additional tank (referred to herein as a feeder tank) in order to generate negative backpressure at the printhead nozzles that are fluidly connected to the respective ink supply reservoirs 12A-12D. In other examples, (described in more detail in reference to FIGS. 7-9B) different interconnects may be used in order to generate the negative backpressure. The terms “negative pressure”, “negative backpressure”, or “negative gauge pressure” refer to the state of an area in which fluid is drawn towards the area from an area of positive pressure. The pressure differential between the areas can cause the ink (or other printing fluid) to move from the ink supply reservoir 12A-12D, through the fluid conduit 14A-14D, and to the print cartridge (or other applicator) to continuously replenish the ink (or other printing fluid) in the print cartridge for deposition onto the medium during a print job. The negative backpressure can also reduce ink drool from the printhead nozzles.

In an example, the ink supply reservoir 12A-12D contains the low-conductivity ink. In some examples, ink supply reservoir 12A-12D may be able to contain from about 0.05 liters to about 5 liters of the low-conductivity ink or another print fluid. In some examples, the ink supply reservoir 12A-12D may be able to contain 0.07 liters, 0.08 liters, 1 liter, etc. In one of these examples, the ink supply reservoir 12A-12D may be able to contain about 5 liters of the low-conductivity ink. In another one of these examples, the ink supply reservoir 12A-12D may be able to contain about 350 milliliters of the low-conductivity ink. While several examples have been provided, it is to be understood that the ink supply reservoir 12A-12D may have a larger or smaller capacity depending on the design and intended purpose of the printer.

An individual ink supply reservoir 12A-12D is connected to and in fluid communication with an individual printhead by a fluid conduit 14A-14D. In some examples, the fluid conduit 14A-14D is a tube. The tube may be a flexible tube to accommodate motion of the printhead. Examples of suitable tube materials include silicone tubing or polyethylene tubing. In the example shown in FIG. 1, each fluid conduit 14A-14D is operatively connected to a respective outlet 18A-18D of the ink supply reservoir 12A-12D. In an example, each fluid conduit 14A-14D may supply a different color or type of liquid ink/print fluid to different ones of a plurality of printheads of the printer. In some examples, the fluid conduit 14A-14D may include additional components, such as various additional interfaces and/or connectors to mate with existing connections on the printer.

Printing Systems

In some examples, the low-conductivity ink and the continuous ink supply system 10 described herein may be combined with a printer as part of a printing system. An example of the printing system 20 is schematically depicted in FIG. 2. Each example of the printing system 20 includes the continuous ink supply system 10 and the printer 22, which includes a plurality of printheads 24.

Examples of the continuous ink supply system 10 described herein may be employed to retrofit or modify existing ink deposition systems, such as printer 22, to provide the printer 22 with a continuous ink supply. In these examples, the continuous ink supply system 10 is separate from the printer 22. Also in these examples, the ink supply reservoirs 12A-12D may be physically located outside of the body of the printer 22, and the fluid conduits 14A-14D may be fed through an inlet of the printer 22 in order to be fluidly and operatively connected to the printheads 24.

Other examples of the continuous ink supply system 10 described herein may be included as part of the ink deposition system of the printer 22, e.g., as either standard or optional equipment. In some of these examples, the ink supply reservoirs 12A-12D are part of a tray that is located at one of the exterior sides of the printer frame. In other of these examples, the ink supply reservoirs 12A-12D are integrated inside of the printer frame.

In an example, the printing system 20 comprises: a printer 22 including a plurality of printheads 24; a continuous ink supply system 10 including: an ink supply reservoir 12A-12D; and a conduit 14A-14D fluidly connecting the ink supply reservoir 12A-12D to the plurality of printheads 24; and a low-conductivity ink contained in the ink supply reservoir 12A-12D, the low-conductivity ink including: a self-dispersed carbon black pigment; a non-ionic surfactant; a co-solvent; and a balance of water; wherein the low-conductivity ink has a conductivity of 400 μS/cm or less. It is to be understood that any example of the low-conductivity ink and/or the continuous ink supply system 10 described herein may be used in examples of the printing system 20.

In addition to the low-conductivity ink and the continuous ink supply system 10, the printing system 20 includes the printer 22. The printer 22 may be an inkjet printer. In various examples, the printer 22 includes a plurality of printheads 24. Each printhead 24 includes an ejector to eject the low-conductivity ink as either droplets or a as a continuous stream. The ejector of the printhead 24 may eject the ink according to any of a variety of techniques including, but not limited to, thermal resistance (e.g., thermal inkjet), piezoelectric deformation (e.g., piezoelectric inkjet), or an ink pump. In some examples, the (plurality of) printheads 24 are thermal inkjet printheads or piezoelectric printheads. In some of these examples, the (plurality of) printheads 24 are thermal inkjet printheads, and the printer 22 is a thermal inkjet printer. In others of these examples, the (plurality of) printheads 24 are piezoelectric printheads, and the printer 22 is a piezoelectric printer.

The printheads 24 may be part of a print cartridge, pen, or other applicator that deposits an ink (or other printing fluid) onto a medium 26 during a print job. During a print job of the printing system 20, the print cartridge deposits the ink (or other printing fluid) onto the medium 26, which can cause the negative gauge pressure inside of the print cartridge.

Referring now to FIG. 3, an example of the printing system 20′ is depicted. The continuous ink supply system 10′ in the printing system 20′ includes an additional tank (feeder tank 13). In the printing system 20′, this feeder tank 13 is at a lower position than the printheads 24 such that gravity will pull the print fluid away from the nozzle(s) 25. Furthermore, since the feeder tank 13 is positioned below the printheads 24, a backpressure will be generated at the nozzle(s) 25 to reduce the likelihood of drool. The flow of the print fluid (e.g., the low-conductivity ink) from the ink supply reservoir 12A to the feeder tank 13 is to be controlled such that the weight of the print fluid in the larger tank (e.g., the ink supply reservoir 12A) does not apply pressure on the print fluid at the nozzle(s) 25. In this example, the flow control is to be carried out without the use of valves and other potentially complicated components.

This example of the continuous ink supply system 10′ includes the ink supply reservoir 12A, the feeder tank 13, a vent port 17, an exchange port 15, the outlet 18A, and the fluid conduit 14A.

The ink supply reservoir 12A is to store a bulk amount of print fluid, such as the low-conductivity ink disclosed herein. The position of the ink supply reservoir 12A in the printer 22 (not specifically shown in FIG. 3) is not particularly limited. In the example shown in FIG. 3, the ink supply reservoir 12A is positioned at a relatively high position, which is partially above a nozzle 25 of a printhead 24 to which the ink supply reservoir 12A is to supply the print fluid. The ink supply reservoir 12A may be easily accessible to a user or an administrator of the printer 22 for servicing, such as refilling or replacing the ink supply reservoir 12A when it is at or near empty.

The feeder tank 13 is in fluidic communication with the ink supply reservoir 12A and the nozzle(s) 25 of the printhead 24. In this example, the example, the feeder tank 13 includes the outlet 18A leading to the printhead 24. As depicted, the feeder tank 13 is to be disposed within the printer 22 below the nozzle(s) 25 at a relatively lower position.

In the present example, the feeder tank 13 further includes a vent port 17 disposed thereon. The vent port 17 vents the feeder tank 13 to atmospheric pressure. In the present example, the vent port 17 may be a simple opening. In other examples, the vent port 17 may include a filter to prevent contaminants from entering the feeder tank 13. In further examples, the vent port 17 may also include a valve or other mechanism to prevent print fluid from escaping via the vent port 17.

By positioning the feeder tank 13 below the nozzle(s) 25 and by venting the surface of the print fluid in the feeder tank 13 to atmospheric pressure, a natural backpressure is maintained at the nozzle(s) 25.

The exchange port 15 is to connect the ink supply reservoir 12A to the feeder tank 13 and to control the flow of the print fluid from the ink supply reservoir 12A to the feeder tank 13. By controlling the flow of the print fluid from the ink supply reservoir 12A to the feeder tank 13, the weight of the print fluid in the ink supply reservoir 12A is prevented from pushing the print fluid out of the vent port 17.

In an example, the exchange port 15 is to limit the flow of print fluid such that print fluid does not flow from the ink supply reservoir 12A into the feeder tank 13 unless the level of print fluid within the feeder tank 13 decreases below a threshold amount, such as about 5 mL (5 cm³ or cc). This threshold amount is not limited, and it is to be understood that more or less print fluid may be maintained in the feeder tank 13. The threshold amount represents a physical level within the feeder tank 13, such as a vertical height of about 5 millimeters above the bottom of the feeder tank 13. The feeder tank 13 is also to maintain a volume of air (referred to as the feeder tank air) that is to be equilibrated with atmospheric pressure via the vent port 17. The volume of the air in the feeder tank 13 is not limited and may be substantially the same as the amount of print fluid maintained at the threshold amount to improve robustness. However, it is to be appreciated that, in some examples, the threshold amount of print fluid and the feeder tank air may be at any suitable levels that enable flow control.

In an example, the exchange port 15 controls the flow of print fluid from the ink supply reservoir 12A into the feeder tank 13 by using a sealed characteristic of the ink supply reservoir 12A during operation. In this example, the exchange port 15 is to exchange print fluid with air between the ink supply reservoir 12A and the feeder tank 13.

In one example, the exchange port 15 may be a rigid conduit extending from the ink supply reservoir 12A into the feeder tank 13. When the ink supply reservoir 12A is replaceable reservoir, the exchange port 15 may include a connector, such as a threading, to receive the ink supply reservoir 12A. As illustrated in FIG. 3, when the level of print fluid in the feeder tank 13 reaches the bottom of the exchange port 15, a seal is created such that air cannot enter the ink supply reservoir 12A via the exchange port 15. The print fluid cannot leave the ink supply reservoir 12A without any air to displace the print fluid, and thus the ink supply reservoir 12A is sealed. In other words, the atmospheric pressure of the feeder tank air on the surface of the print fluid within the feeder tank 13 will balance with the weight of fluid in the ink supply reservoir 12A.

As the print fluid leaves the feeder tank 13 via the outlet 18A, the level of print fluid in the feeder tank 13 may decrease and eventually leave a gap between the bottom of the exchange port 15 and the surface of the print fluid in the feeder tank 13. In these instances, as the surface of the print fluid drops below the bottom of the exchange port 15, air may enter the exchange port 15 and move up into the ink supply reservoir 12A to displace some of the print fluid. Accordingly, as air enters the ink supply reservoir 12A, print fluid will flow into the feeder tank 13 due to the air displacing the volume of print fluid. As the print fluid enters the feeder tank 13, the level of the print fluid will rise until it reaches the bottom of the exchange port 15 such that no more air may enter the ink supply reservoir 12A. It is to be understood that when the level of the print fluid rises to this height, the condition shown in FIG. 3 reached and the flow of print fluid from the ink supply reservoir 12A to the feeder tank 13 is stopped again until the level drops below the bottom of the exchange port 15 again. Therefore, in this example, the threshold amount at which the print fluid in the feeder tank 13 is maintained is substantially equal to the vertical height between the bottom of the feeder tank 13 and the bottom of the exchange port 15.

While not shown in FIG. 3, the ink supply reservoir 12A may include an inlet port 11 (see FIG. 1), e.g., when the ink supply reservoir 12A is refillable. The inlet port 11 is not particularly limited and is generally to interface with a print fluid supply (not shown), such as a bottle of print fluid having a complementary interface. For example, the inlet port 11 may be a simple mechanism such as a hole through which print fluid may be added. It is to be appreciated that in examples where the ink supply reservoir 12A is vented to the atmosphere, the exchange port 15 is to be sealed to avoid print fluid from flooding the feeder tank 13 and moving up the vent port 17.

The inlet port 11 may provide an airtight seal such that air is exchanged with the print fluid supply. The inlet port 11 may include an air vent (not shown) and a fluid passage (not shown). During refilling of the ink supply reservoir 12A, print fluid (e.g., the low-conductivity ink disclosed herein) from the print fluid supply may flow into the ink supply reservoir 12A. As the ink supply reservoir 12A fills with print fluid, air is to be displaced and exits through the air vent into the print fluid source. When the print fluid source is a bottle of print fluid, air from the ink supply reservoir 12A replaces the print fluid in the bottle. Accordingly, the filling process in the present example is carried out in a closed system. By maintaining the closed system, the amount of liquid entering the ink supply reservoir 12A will not exceed the amount of volume available in the ink supply reservoir 12A.

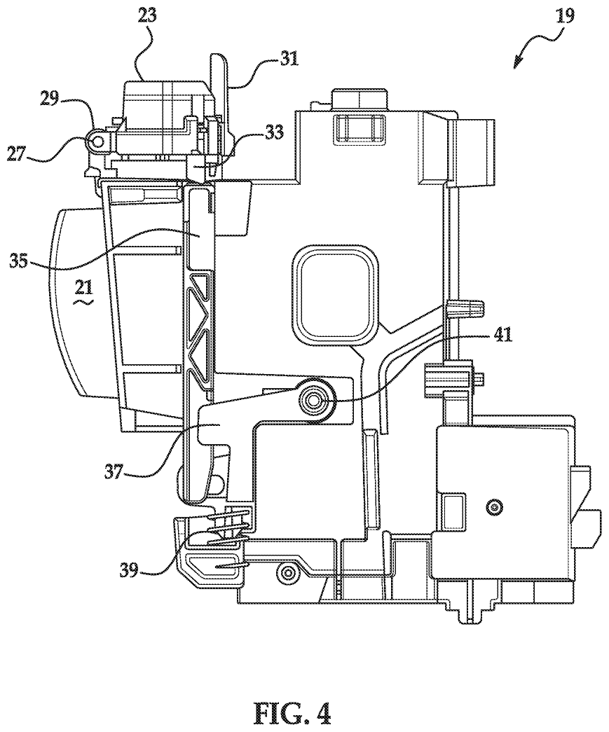

In one example, the ink supply reservoir 12A and the feeder tank 13 are included in an ink tank. An example of an ink tank is shown and described in reference to FIGS. 4, 5, and 6A-6C. In this example, the ink supply reservoir 12A is refillable, and the ink tank includes a cap assembly that enables the desired negative backpressure within the printhead 24 to be maintained.

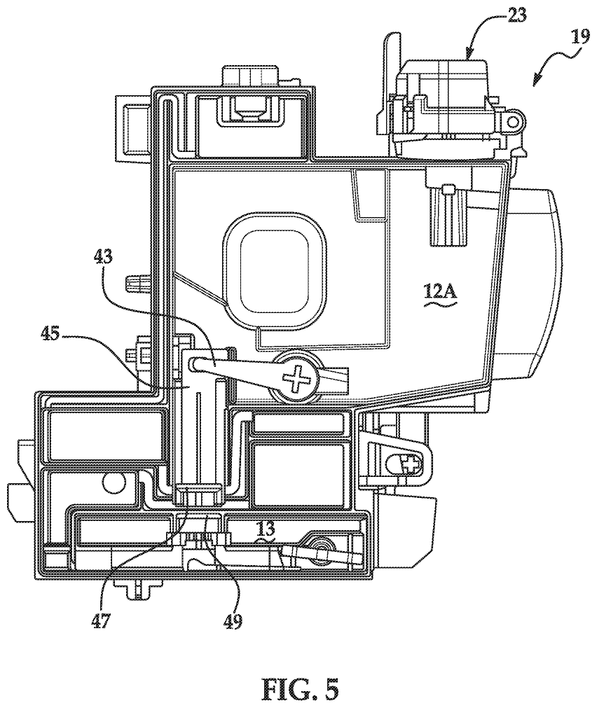

Referring now to FIG. 4, a first side view of the example ink tank 19 is depicted. The ink tank 19 includes an ink tank body 21, which may include, in its interior, a single ink supply reservoir 12A (shown in FIG. 5) or multiple ink supply reservoirs 12A-12D.

The example ink tank 19 also includes a cap assembly 23 attached to the ink tank 19 with a hinge 27. Hinge 27 may be any type of hinge that constrains the rotation of the cap assembly 23 to a single axis of rotation. In one example, the hinge 27 may be an axle engaged with cylindrical bearings extending from the cap assembly 23. The hinge 27 may be preloaded with an elastic band 29 disposed around the hinge 27 to apply an opening force to the cap assembly 23, such that when the cap assembly 23 is unlatched, the opening force applied by the elastic band 29 rotates the cap assembly 23 to a fully opened position and maintains the cap assembly 23 in the fully opened position until the force is overcome by force applied by a user to close the cap assembly 23.

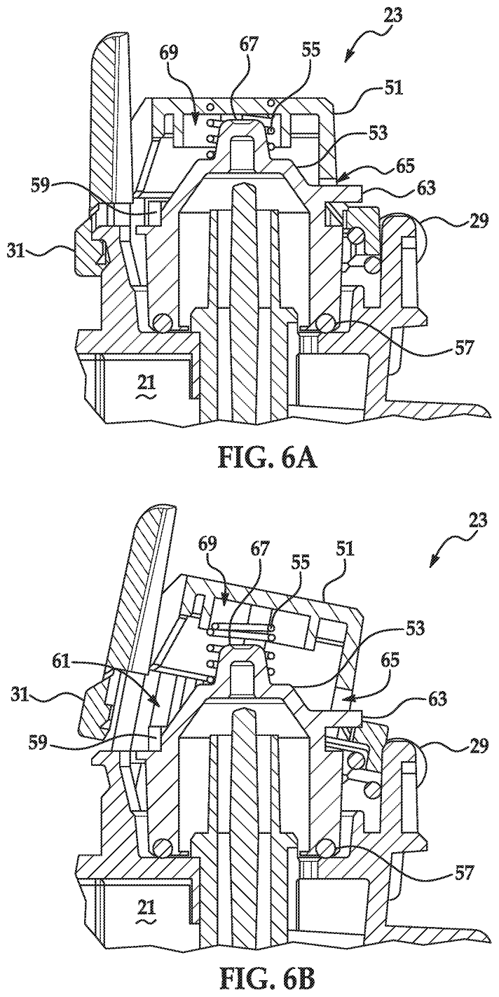

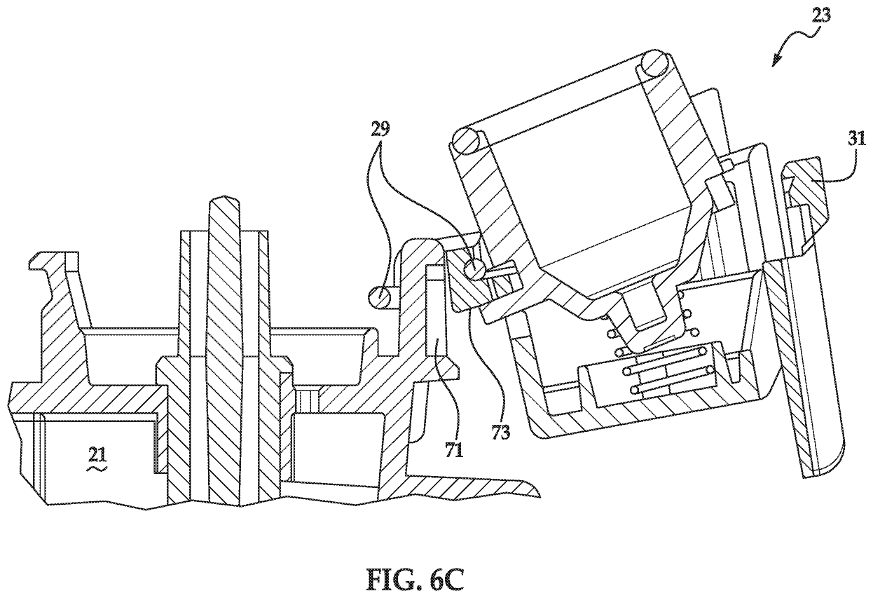

As shown in FIG. 4, the ink tank 19 also includes a latch 31 to hold the cap assembly 23 in a closed position against the opening force applied by the elastic band 29. Accordingly, the cap assembly 23 is constrained to two stable states: a closed state (closed position) as illustrated in FIGS. 4, 5 and 6A when the latch 31 is engaged, and a fully opened state (fully opened position) as illustrated in FIG. 6C when the latch 31 is released.

In the closed state, an effector 33 (an extension of the cap assembly 23) extends downward from the cap assembly 23 to depress a slider 35, which is retained in a channel in the body 21 of the ink tank 19. The slider 35 may be retained by any suitable mechanism, such as by channels or tabs, for example. In the closed position, the slider 35 is engaged with a cam on lever arm 37 that is spring loaded by a spring 39, and holds the lever arm 37 in a downward position against the force of the spring 39. Lever arm 37 is fixed to a rotatable spline 41 that extends into the interior of the ink tank body 21. In one example, spline 41 may be held in place by a snap-ring or c clip, and sealed by an O-ring or the like as it passes through the wall of the ink tank body 21.

In the interior of the ink tank body 21, the spline 41 is fixed to a second lever arm 43 (shown in FIG. 5). In FIG. 5, the second lever arm 43 is connected to a valve body 45 by a pin (not shown) that is fixed with respect to second lever arm 43 and that is free to rotate with respect to valve body 45. In this example, the valve body 45 includes a valve seal 47 that is to provide a seal when seated in a valve seat 49 in the ink tank 19. It will be appreciated that in the closed cap configurations illustrated in FIGS. 4 and 5, the lever arm 37 is held in a downward rotated position by the slider 35, that second lever arm 43 is held in an upward rotated position by its fixed connection to lever arm 37 via spline 41, and that the valve assembly including valve seal 47 and valve seat 49 is held open.

As shown in FIG. 5, the valve assembly, which includes second lever arm 43, valve body 45, and valve seal 47, is positioned between the ink supply reservoir 12A and the feeder tank 13, and thus permits fluid communication between the ink supply reservoir 12A and the feeder tank 13. This valve assembly may be one example of the exchange port 15 of FIG. 3.

FIGS. 6A through 6C illustrate the cap assembly 23 in three different states or positions. FIG. 6A illustrates the cap assembly 23 in the closed position; FIG. 6B illustrates the cap assembly 23 in a transient, partially open state after the cap assembly 23 has been unlatched by the operation of latch 31; and FIG. 6C illustrates the cap assembly 23 in the fully opened position.

As illustrated in FIG. 6A, the cap assembly 23 includes a cap housing 51, a bung 53 retained within the cap housing 51, and a spring 55 disposed between the cap housing 51 and the bung 53. In one example, the cap housing 51 may be fabricated from an acetal homopolymer thermoplastic such as DELRIN® (DuPont USA) and the bung 53 may be fabricated from a natural or synthetic elastic polymer, such as natural rubber or silicone rubber.

Also shown in FIG. 6A are the ink tank body 21 (partial), the elastic band 29, and the latch 31, previously described herein.

In the closed (latched) position illustrated in FIG. 6A, the spring 55 is compressed between the cap housing 51 and the bung 53 and applies a sealing force between the bung 53 and the ink tank body 21. In one example, the bung 53 may include an O-ring 57 to improve the seal between the bung 53 and the ink tank body 21. As shown in FIG. 6A, the bung 53 is retained within cap housing 51 by a number of complementary features including tabs or protuberances from the bung 53 and openings, cavities or channels in the cap housing 51. These complementary features include tab 59 of the bung 53 in a channel 61 (hidden in FIG. 6A, but shown in FIG. 6B) of the cap housing 51, tab 63 of the bung 53 in opening 65 of the cap housing 51, and crown 67 of the bung 53 in cavity 69 of the cap housing 51. It will be appreciated that these complementary features will allow for relative motion between the cap housing 51 and the bung 53 when the cap assembly 23 is unlatched.

When the cap assembly 23 is in the closed position, the valve assembly described in reference to FIG. 5 is open, and thus the low-conductivity ink (or other print fluid) contained in the ink supply reservoir 12A (FIG. 5) is able to flow through to the feeder tank 13 and ultimately to the printhead(s) 24.

Referring now to FIG. 6B, the cap assembly 23 is shown in a transient, partially open state after the cap assembly 23 has been unlatched by the operation of latch 31. This transient state is achieved by the combined forces of spring 55 and hinge 27. In one example, the angle of rotation of the cap assembly 23 in the transient, partially open position relative to the closed position may be in the range of from about 10° to about 14°.

When the latch 31 is released, spring 55 applies a force to push the cap housing 51 away from the bung 53 while maintaining a sealing force between the bung 53 and the ink tank body 21. It will be appreciated that this force decreases as spring 55 decompresses and that the relative motion of the cap housing 51 and the bung 53 is limited by the complementary features of the cap housing 51 and the bung 53 described herein.

In the transient state shown in FIG. 6B, the tab 63 is constrained by opening 65, the crown 67 (with spring 55) has moved within cavity 69, and the tab 59 has reached the lower bound of channel 61, which limits further relative motion between the cap housing 51 and the bung 53.

This transient position serves to actuate a valve in the ink tank 19 (using other features of the cap assembly 23) to effect a secondary seal in the ink tank body 21 before the seal between the bung 53 and the ink tank body 21 is broken. After the cap assembly 23 reaches the transient position, further motion of the cap assembly 23 is controlled by the force applied to the cap assembly 23 by the elastic band 29. This force rotates the cap assembly 23 to a fully open position (shown in FIG. 6C).

In this transient position, the cap assembly 23 is partially open, such that the cap housing 51 is partially rotated and the seal between the bung 53 and the ink tank body 21 is maintained. However, the holding force applied by effector 33 is removed from slider 35, which allows the force of spring 39 to rotate lever arm 37 upward. As a result, the second lever arm 43 is rotated downward, which translates through valve body 45 to seat valve seal 47 into value seat 49, thereby providing a seal between ink supply reservoir 12A and feed tank 13 and preventing fluid communication between the ink supply reservoir 12A and the feed tank 13.

FIG. 6C illustrates the cap assembly 23 in the fully open position. In this state, further rotation is limited by interference between a sidewall 71 of the ink tank body 21 and a flange 73 of the hinge 27 (not visible in FIG. 6C).

In the fully open position, the internal seal between valve seal 47 and valve seat 49 will be maintained as the cap assembly 23 rotates from the transient position to the fully opened position because the effector 33 remains disengaged from the slider 35, allowing the spring 39 to hold the lever arm 37 in its upward rotated position. This position of lever arm 37 corresponds to the seating of valve seal 47 in valve seat 49, which seals off fluid communication between the ink supply reservoir 12A and the feed tank 13. The seal between the ink supply reservoir 12A and the feed tank 13 isolates the ink supply reservoir 12A to prevent gravitationally induced pressure from causing ink drool at the printhead(s) 24.

Referring back to FIG. 2, the printing system 20 may also include an interconnect 28 that substantially limits, or in some examples substantially prevents, flow of a fluid in one direction while allowing flow in another direction. When included, the interconnect 28 is positioned between the continuous ink supply system 10, 10′ and the printhead 24 along a flow path of the ink or other printing fluid. In some examples, the interconnect 28 is located along the fluid conduit 14A-14D. As one example (as shown in FIG. 8), the interconnect 28 may be located at a terminus of the fluid conduit 14A-14D. In another example, the interconnect 28 is located at a beginning of the fluid conduit 14A-14D. In yet another example, the interconnect 28 is located within the fluid conduit 14A-14D away from either the terminus or the beginning of the fluid conduit 14A-14D. In still other examples, the interconnect 28 may not be part of the fluid conduit 14A-14D, but rather, may be integral to a cartridge housing, as described below in reference to FIG. 7.

FIG. 7 illustrates one example of an interconnect 28A that is formed in the print cartridge 30. The interconnect 28A is shown in a closed configuration. It is switchable between the closed configuration and an open configuration.

The print cartridge 30 includes a printhead 24. In this example, the print cartridge 30 is separable from the printhead 24 at a connector 34. The connector 34 may serve as a liquid ink port of the printhead 24, for example. In other examples (not illustrated), the printhead 24 and the print cartridge 30 may be permanently connected. For example, the print cartridge 30 may include the printhead 24.

The print cartridge 30 includes a fluid reservoir 36 that is configured to hold ink for use by the printhead 24. A housing 38 substantially encloses and, in some examples, substantially defines the fluid reservoir 36. The print cartridge 30 further includes a variable chamber 40 within the housing 38 in fluid communication with the fluid reservoir 36. The variable chamber 40 is configured to expand and contract in response to pressure changes in the ink within the fluid reservoir 36. Specifically, the variable chamber 40 expands when a pressure of the ink decreases and contracts as the ink pressure increases relative to an ambient pressure outside of the housing 38 and the fluid reservoir 36.

In the example shown in FIG. 7, the interconnect 28A is substantially located within the fluid reservoir 36 and includes an interconnect port 42 formed through a wall of the housing 38 to access an exterior of the print cartridge 30. In some examples (e.g., as illustrated), the housing 38 provides or serves as a structural member of the interconnect 28A. As such, the interconnect 28A is also integral to the housing 38, and by extension, is also integral to the print cartridge 30.

In this example, the fluid conduit 14A-14D includes a tube connected to an interconnect port 42. In some examples, the interconnect port 42 may be located on a side of the ink cartridge 30 that is adjacent to another ink cartridge when installed in the printer 22. A connection between the tube (fluid conduit 14A-14D) and the interconnect port 42 may be configured to accommodate a relatively small spacing between adjacent ink cartridges 30 in the printer 22. For example, the tube (fluid conduit 14A-14D) may be connected to the interconnect port 42 using a low-profile, right-angle connector, to facilitate accessing the interconnect port 42 when the print cartridge 30 is inserted in the printer 22 adjacent to other print cartridges 30.

The interconnect 28A further includes a lever 44 that is to move in response to an expansion and a contraction of the variable chamber 40 within the fluid reservoir 36. In particular, as the variable chamber 40 expands, the lever 44 is moved away from an upper wall 46a and toward a lower wall 46b of the housing 48, as illustrated by a double-headed arrow in FIG. 7. The variable chamber 40 may expand in response to a decrease in ink pressure within the fluid reservoir 36. The decrease in ink pressure may be produced as ink is consumed by the printhead 24. A motion of the lever 44 in cooperation with the expansion and contraction of the variable chamber 40 may be constrained or resisted by a spring 48 or a similar bias element that acts against the movement of the lever 44 away from the upper wall 46a. The lever 44 may rest on and rotate about a fulcrum 50.

This example of the interconnect 28A further includes a sealing member 52 located between the lever 44 and an opening 54 in the housing 38 that leads to the interconnect port 42. The sealing member 52 is movable by or in response to movement of the lever 44. Specifically, the sealing member 52 is movable between a first position in which the opening 54 is substantially sealed (e.g., blocked by the sealing member 52) and a second position in which the opening 54 is unsealed. When sealed, fluid (e.g., the low-conductivity ink) is prevented from passing through the opening 54; and when unsealed, fluid may pass through the opening 54.

In some examples, the sealing member 52 may be moveable into the first (sealed) position by a positive ink pressure within the fluid reservoir 36 at a printhead side of the interconnect 28A. In particular, positive ink pressure moves the sealing member 52 into the first position and seals the opening 54, irrespective of a position of the lever 44. Positive pressure may be provided by using a pump (e.g., an air pump) to expand the variable chamber 40.

In some examples, the sealing member 52 may be a substantially spherical ball (e.g., as illustrated in FIG. 7). When the sealing member 52 is a spherical ball, the opening 54 may be a circular hole in the housing 38. In the first (sealed) position, the ball-shaped sealing member 52 may be pressed into and sealed against a circular rim of the opening 54. In these examples, the housing 38 provides a structural member (e.g., the opening 54) of the interconnect 28A. In these examples, the interconnect 28A is integral to the housing 38. In other examples (not illustrated), the opening 54 may be defined by a structural member that is separate from the housing 38 and then affixed and sealed into the housing 38.

The size and shape of the opening 54 depend on the size and the shape of the sealing member 52. In some examples, one or both of the sealing member 52 and a rim or other contact surface between the sealing member 52 and the opening 54 may include a hydrophilic material. The hydrophilic material may be a coating. The hydrophilic material may lower the bubble pressure at an interface between the sealing member 52 and opening 54, for example.

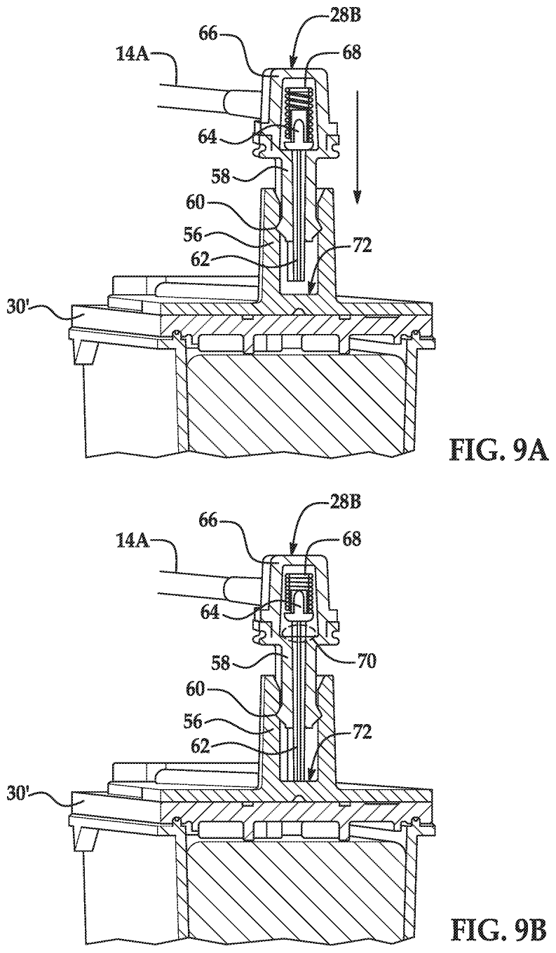

FIG. 8 illustrates another example of an interconnect 28B, which is located at a terminus of the fluid conduit 14A-14D. In this example, the interconnect 28B is operatively positioned within an inlet 56 of another example of the print cartridge 30′. This example of the interconnect 28B can be disconnected from the print cartridge 30′. The interconnect 28B is described in more detail in reference to FIGS. 9A and 9B.

As shown in FIGS. 9A and 9B, the interconnect 28B includes a valve neck 58, first seal member 60, actuator 62, second seal member 64, and valve main body 66.

As used herein in the example shown in FIGS. 9A and 9B, the term “valve main body” refers to a physical structure including a section of interconnect 28B, and the term “valve neck” refers to a slender physical structure including a section of the interconnect 28B that can be longer and narrower in dimension relative to the valve main body 66.

In some examples, the valve main body 66 and valve neck 58 can be a single unitary element, i.e., a single unitary piece of material. In other examples, the valve main body 66 and the valve neck 58 can be separate elements that interface together to form the interconnect 28B.

The interconnect 28B includes the actuator 62. As used herein, the term “actuator” refers to a mechanism to initiate an action. For example, the actuator 62 can initiate flow of the low-conductivity ink (or other print fluid) when the interconnect 28B is connected to print cartridge 30′, as shown in FIG. 8.

As illustrated in FIGS. 9A and 9B, the actuator 62 can be located in the valve neck 58 and valve main body 66. For example, the actuator 62 can include dimensions such that a portion of the actuator 62 is located in valve neck 58 and a portion of actuator 62 is located in valve main body 66.

The actuator 62 can include a second seal member 64. Like sealing member 52 (in FIG. 7), the seal member 64 is a mechanism for preventing fluid communication between a first location (valve main body 66) and a second location (valve neck 58). For example, the seal member 64 can form a seal (e.g., preventing fluid communication) within the valve main body 66 while the valve neck 58 is detached from the inlet 56 of the print cartridge 30′. Seal member 64 can prevent or allow fluid communication between valve main body 66 and valve neck 58, as is further described herein.

Seal member 64 can include an elastomeric material. The elastomeric material may be a polymer material having viscoelastic properties. The elastomeric material of the seal member 64 can provide the fluid tight seal between the valve main body 66 and valve neck 58. The fluid tight seal can be provided by seal member 64 while interconnect 28B is detached from print cartridge 30′.

The fluid tight seal provided by the elastomeric material of seal member 64 can maintain negative pressure within valve main body 66. In an example in which a user disconnects the interconnect 28B from print cartridge 30′, the fluid tight seal provided by seal member 64 can maintain the tendency of the ink to flow from the ink supply reservoir 12A-12D, and through a fluid conduit 14A-14D to interconnect 28B. The fluid tight seal provided by seal member 64 can maintain a prime of ink (or other printing fluid) in the fluid conduit 14A-14D when the interconnect 28B is disconnected from print cartridge 30′.

Actuator 62 may have a length that is greater than a combined length of valve main body 66 and valve neck 58. For example, the actuator 62 length may be such that a portion of actuator 62 protrudes from a bottom portion of valve neck 58. The protruding portion of actuator 62 can contact a surface of the print cartridge 30′ to cause actuator 62 to move to allow communication of ink from the valve main body 66 to the valve neck 58 and to the print cartridge 30′.

The valve neck 58 can include first seal member 60. Seal member 60 can provide a seal between valve neck 58 and an inlet 56 of the print cartridge 30′ when interconnect 28B is attached to inlet 56 of the print cartridge 30′. In one example, seal member 60 can contact (and create a seal) with inlet 56 prior to contact between actuator 62 and inlet 56.

Similar to seal member 64, seal member 60 can include an elastomeric material. The elastomeric material of seal member 60 can provide the fluid tight seal between valve neck 58 and inlet 56. The fluid tight seal can be provided by seal member 60 while the interconnect 28B is attached to print cartridge 30′.

FIG. 9A specifically illustrates the seal member 64 providing a seal within valve main body 66 of the interconnect 28B, and FIG. 9B specifically illustrates the seal member 60 providing a seal between valve neck 58 and inlet 56.

In this example, the print cartridge 30′ can receive the low-conductivity ink from the ink supply reservoir 12A via fluid conduit 14A and interconnect 28B.

In FIG. 9A, the interconnect 28B is in a partially detached state with respect to print cartridge 30′. In this partially detached state (in which seal member 60 is still in contact with inlet 56), no low-conductivity ink (or other print fluid) is able to flow through interconnect 28B and negative pressure in valve main body 66 is maintained. In FIG. 9A, the interconnect 28B can begin to be attached to print cartridge 30′.

For example, interconnect 28B can begin to be lowered towards print cartridge 30′ such that valve neck 58 is inserted into inlet 56. As the valve neck 58 is inserted into inlet 56, the seal member 60 provides a seal between valve neck 58 and the inlet 56 of the print cartridge 30′. Seal member 60 can provide the seal via an interference fit. As used herein, the term “interference fit” refers to a fit between two parts in which an external dimension of a first part slightly exceeds an internal dimension of a second part into which the first part is to fit. For example, the external dimension of seal member 60 can slightly exceed an internal dimension of inlet 56 such that the internal dimension of inlet 56 can compress seal member 60 to provide the seal between inlet 56 and valve neck 58.

As illustrated in FIGS. 9A and 9B, the valve main body 66 includes biasing member 68. Biasing member 68 can be connected to actuator 62. As used herein, the term “biasing member” refers to a mechanism to exert a force to influence another object. For example, the biasing member 68 can exert a force on the actuator 62 to cause the actuator 62 to remain stationary until acted on by another force. That is, biasing member 68 can exert a force on actuator 62 to cause actuator 62 to remain stationary such that seal member 64 provides a seal between valve neck 58 and valve main body 66 to maintain negative pressure in valve main body 66 until interconnect 28B is attached to the print cartridge 30′.

The biasing member 68 may be a spring. As used herein, the term “spring” refers to an elastic mechanical object that stores mechanical energy. In some examples, the spring can be a helical/coil spring. For example, the spring can be naturally in an extended state, and in response to an application of a force to the spring, may be moved to a compressed (e.g., a deflected) state.

As illustrated in FIG. 9A, the biasing member 68 is in an extended state. As used herein, the term “extended state” refers to a state in which biasing member 68 is stretched out from its compressed state. While interconnect 28B is detached from inlet 56 of print cartridge 30′, biasing member 68 can be in the extended state. In this state, the fluid conduit 70 between valve neck 58 and valve main body 66 is closed by seal member 64. Keeping biasing member 68 in an extended state while interconnect 28B is detached from inlet 56 forms the seal within valve main body 66. This maintains negative pressure in valve main body 66.

As the valve neck 58 is lowered towards the print cartridge 30′ into inlet 56, seal member 60 can form a seal between valve neck 58 and inlet 56 of the print cartridge 30′. Seal member 60 can maintain the seal between valve neck 58 and inlet 56 while interconnect 28B is attached to print cartridge 30′. As the valve neck 58 is lowered towards the print cartridge 30′ into the inlet 56, the protruding portion of actuator 62 (e.g., the portion of actuator 62 protruding from valve neck 58) can be moved towards a lower surface 72 of the inlet 56.

The term “lower surface” refers to a strip of rigid material included in inlet 56 that actuator 62 can contact to move biasing member 68 from the extended state to a compressed state. As used herein, the term “compressed state” refers to a state in which biasing member 68 is pressed together.

The lower surface 72 can span a width of the inlet 56. The lower surface 72 can be adjacent to an aperture included in inlet 56 such that actuator 62 can contact the lower surface 72, and the ink or other print fluid can flow around the lower surface 72 and through the aperture into print cartridge 30′.

As illustrated in FIG. 9B, the interconnect 28B can be lowered such that the lower surface 72 can apply a force to actuator 62. In response to the application of force to actuator 62, biasing member 68 can move from an extended state to a compressed state.

By applying force to the actuator 62 by the lower surface 72 as the interconnect 28B is moved towards the print cartridge 30′, the actuator 62 and biasing member 68 can be moved in the opposite direction (e.g., upwards). This causes the biasing member 68 to be moved to a compressed state and causes the seal member 64 attached to the actuator 62 to be moved upwards. By moving seal member 64 upwards, flow of ink from interconnect 28B to print cartridge 30′ can be enabled.

As a result of the seal member 64 being moved upwards, fluid conduit 70 can be opened. As fluid conduit 70 is opened, ink included in fluid conduit 14A can be moved through valve main body 66, through fluid conduit 70, through valve neck 58, around lower surface 72, and into print cartridge 30′. As a result of seal member 60 creating a seal between valve neck 58 and inlet 56 prior to seal member 64 being moved to open fluid conduit 70, negative pressure in valve main body 66 can be maintained. Maintaining negative pressure in valve main body 66 can cause the low-conductivity ink (or other print fluid) to be continually supplied to print cartridge 30′ during print jobs to allow the printer 22 to continue to perform print jobs.

The interconnect 28B can also be detached from the print cartridge 30′. As interconnect 28B is moved away from print cartridge 30′, the biasing member 68 can move from the compressed state to the extended state. As biasing member 68 moves from the compressed state to the extended state, the actuator 62 moves in a downward direction and the seal member 64 can close the fluid conduit 70. This creates the seal between valve main body 66 and the valve neck 58 (e.g., creating the seal within valve main body 66). Seal member 64 can create the seal between valve main body 66 and valve neck 58 prior to seal member 60 losing the seal between valve neck 58 and inlet 56. As the valve neck 58 is moved away from inlet 56, the seal created within valve main body 66 (e.g., between valve main body 66 and valve neck 58) can maintain negative pressure within valve main body 66 as the seal between valve neck 58 and inlet 56 is lost (e.g., as a result of valve neck 58 exiting inlet 56.

In the various examples disclosed herein, the printhead(s) 24 are to receive the low-conductivity ink (or other desirable print fluid) from the continuous ink supply system 10, 10′. It is to be appreciated that the manner by which the printhead(s) 24 receives the print fluid from the continuous ink supply system 10, 10′ is not particularly limited. For example, the printhead(s) 24 may include a motor and/or vacuum to draw the print fluid via the fluid conduits 14A-14D. In other examples, the printhead(s) 24 may use capillary action to draw the print fluid. In still further examples, a pump (not shown) may be added along the fluid conduits 14A-14D.

In other examples, the low-conductivity ink may be contained in an individual printhead applicator, such as consumable inkjet ink cartridges, and printed with inkjet printers that are designed to print from such replaceable cartridges.

To further illustrate the present disclosure, examples are given herein. It is to be understood that these examples are provided for illustrative purposes and are not to be construed as limiting the scope of the present disclosure.

### EXAMPLES

### Example 1

An example of the binder-less, low-conductivity ink disclosed herein (referred to as “Ex. Ink”) was prepared. Ex. Ink included a carbon black pigment with oxidized groups thereon as the self-dispersed carbon black pigment dispersion and did not include any binder or additional polymeric dispersant.

Two comparative inks were also prepared (referred to as “Comp. Ink 1” and “Comp. Ink 2”). Comp. Ink 1 included the same self-dispersed carbon black pigment included in Ex. Ink (i.e., a carbon black pigment with oxidized groups thereon) and an acrylate block polymer as a binder. Comp. Ink 2 included the self-dispersed carbon black pigment with an organic group attached, and an acrylate styrene polymer as a binder.

The general formulation of each of the inks is shown in Table 1, with the wt % active of each component that was used, except for the antimicrobial agent, which is shown as the weight percentage of the “as is” 20% active solution.

TABLE 1

| Ingredient | Specific Component | Ex. Ink | Comp. Ink 1 | Comp. Ink 2 |
|---|---|---|---|---|
| Carbon black | Carbon black pigment with oxidized | 3.75 | 3.75 | — |
| pigment | groups thereon | | | |
| dispersion | Carbon black pigment with organic | — | — | 4.00 |
| | groups attached thereto | | | |
| Binder | Acrylate block polymer | — | 0.966 | — |
| | Acrylate styrene polymer | — | — | 0.75 |
| Co-solvent | 1,5-pentanediol | 7.0 | 7.0 | 4.5 |
| | 2-pyrrolidinone | 6.0 | 6.0 | 7.5 |
| | 2-methyl-1,3-propanediol | — | — | 2.0 |
| Anti-decel agent | LIPONIC ® EG-1 | 4.8 | 4.8 | 4.35 |
| Non-ionic | SURFYNOL ® 465 | 0.10 | 0.10 | 0.10 |
| surfactant | | | | |
| Antimicrobial | ACTICIDE ® B20 (as is 20% solution) | 0.10 | — | — |
| agent | PROXEL ® GXL (as is 20% solution) | — | — | 0.04 |
| Organic salt | Ammonium Benzoate | — | 0.20 | 0.19 |
| Water | Deionized water | Balance | Balance | Balance |

The particle size (in nm and in terms of the volume-weighted mean diameter (Mv) and the D50 (i.e., the median of the particle size distribution, where ½ the population is above this value and ½ is below this value)), pH, conductivity (in μS/cm), surface tension (in dynes/cm), viscosity (in cP), BIGs (number of particles larger than 0.5 μm/mL), UV-Vis (1:5K dilution in water, absorbance reported at 500 nm wavelength), and density (in g/cm³) of each of the inks was measured at 25° C. The results of each of these measurements for each of the inks are shown in Table 2.

TABLE 2

| | Ex. Ink | Comp. Ink 1 | Comp. Ink 2 |
|---|---|---|---|
| Particle size (MV, nm) | 129 | 122 | 118 |
| Particle size (D50, nm) | 123 | 118 | 110 |
| pH | 7.48 | 7.33 | 7.95 |
| Conductivity (μS/cm) | 148 | 1217 | 2010 |
| Surface tension | 45.8 | 46.2 | 46.0 |
| (dynes/cm) | | | |
| Viscosity (cP) | 2.7 | 3.0 | 2.7 |
| BIGs | 8 × 10′ | 6 × 10′ | 1.2 × 10′ |
| UV-Vis | 0.3850 | 0.3826 | 0.3888 |
| Density (g/cm³) | 1.036 | 1.041 | 1.040 |

As shown in Table 2, Ex. Ink had a conductivity that was much lower than the comparative inks. Ex. Ink had a conductivity of 148 μS/cm while Comp. Ink 1 had a conductivity of 1217 μS/cm and Comp. Ink 2 had a conductivity of 2010 μS/cm. The low conductivity of Ex. Ink was unexpected.

### Example 2

Prints were generated using the inks from Example 1 (i.e., Ex. Ink, Comp. Ink 1, and Comp. Ink 2). The prints were generated on multipurpose paper media with COLORLOK® technology (available from International Paper Company) using a HP® cartridge 940 in an OFFICEJET® Pro 8000 (an inkjet printer available from HP Inc.) and an ink amount of 56 ng/300^{th} of an inch.

The durability of each of the prints was tested using a highlighter smear test. For the highlighter smear test, a Faber-Castell highlighter was passed over the print 1 hour after printing. The highlighter was passed over the print, in one or two passes, at a weight pressure of 500 grams. The highlighter smear (i.e., the amount of ink that was smeared passed the end of the print) was measured (in milli Optical density (mOD)) 24 hours after the smear.

The result of the durability test of each print is shown in Table 3. In Table 3, each print is identified by the ink used to generate the print and whether the highlighter was smeared over the print in one or two passes.

TABLE 3

| Ink used to | Number of | Highlighter smear |
|---|---|---|
| generate the print | highlighter passes | (mOD) |
| Ex. Ink | One pass | 70 |
| Ex. Ink | Two passes | 124 |
| Comp. Ink 1 | One pass | 56 |
| Comp. Ink 1 | Two passes | 139 |
| Comp. Ink 2 | One pass | 216 |
| Comp. Ink 2 | Two passes | 378 |

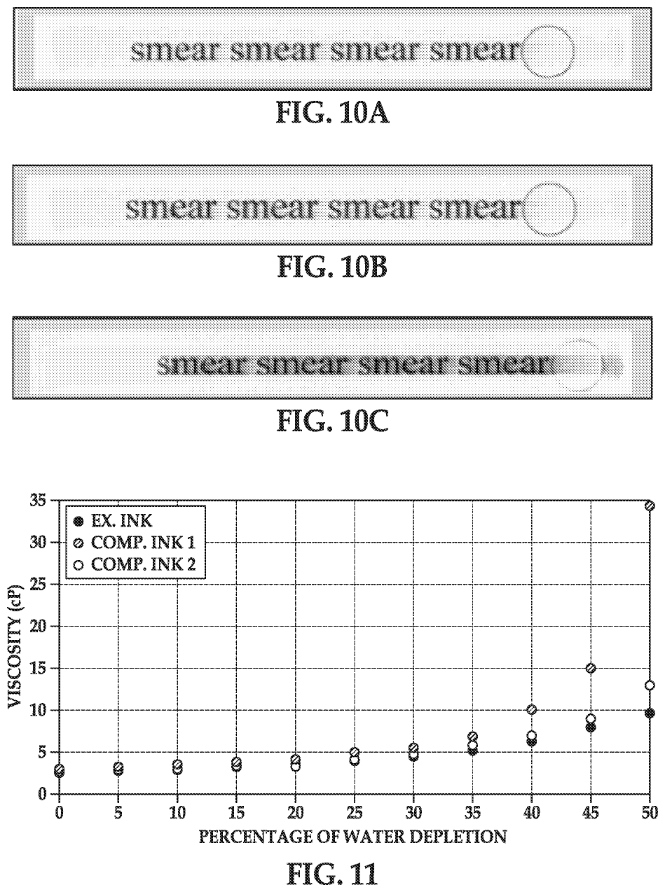

Some of the prints after the durability test are shown (in black and white) in FIGS. 10A through 10C. The print generated with Ex. Ink that had the highlighter smeared over it in one pass is shown in FIG. 10A; the print generated with Comp. Ink 1 that had the highlighter smeared over it in one pass is shown in FIG. 10B; and the print generated with Comp. Ink 2 that had the highlighter smeared over it in one pass is shown in FIG. 10C.

As shown in Table 3 and FIGS. 10A and 10B, the prints generated with Ex. Ink (e.g., FIG. 10A) had an amount of smearing comparable to the amount of smearing of the prints generated with Comp. Ink 1 (e.g., FIG. 10B). As such, the results in Table 3 and FIGS. 10A and 10B indicate that the durability of prints generated with Ex. Ink is comparable to the durability of prints generated with Comp. Ink 1.

As shown in Table 3 and FIGS. 10A and 10C, prints generated with Ex. Ink (e.g., FIG. 10A) had a much lower amount of smearing than the prints generated with Comp. Ink 2 (e.g., FIG. 10C). As such, the results in Table 3 and FIGS. 10A and 10C indicate that the durability of prints generated with Ex. Ink is better than the durability of prints generated with Comp. Ink 2.

### Example 3

A water depletion experiment was conducted on the inks from Example 1 (i.e., Ex. Ink, Comp. Ink 1, and Comp. Ink 2) to assess ink performance upon water evaporation from the ink. For the water depletion experiment, the viscosity (at 25° C.) of the ink was measured as water was depleted from the ink.

The results of the water depletion experiment are shown in FIG. 11. In FIG. 11, the viscosity (in cP at 25° C.) is shown on the Y-axis, and the percentage (by weight) of water depletion is shown on the X-axis.

As shown in FIG. 11, Ex. Ink had a viscosity less than 10 cP at 50% water depletion. Further, Ex. Ink was stable at 50 wt % water depletion. At 40 wt % water depletion, Ex. Ink had good nozzle health. At 40 wt % water depletion, neither Comp. Ink 1 nor Comp. Ink 2 had good nozzle health. At 60 wt % water depletion (viscosity results not shown in FIG. 11), Ex. Ink was able to print full KOD (black optical density) blocks, but nozzle health was challenged. These results indicate that Ex. Ink was better able to withstand water evaporation than Comp. Ink 1 or Comp. Ink 2.

Ex. Ink (from Example 1) and Comp. Ink 2 (from Example 1) were also tested for pigment settling. The recovery level of pens containing Ex. Ink and pens containing Comp. Ink 2 was measured after spinning the pens at 250 rotations per minute (rpm). Recovery was performed in HP Ink Tank Wireless 415 printers using cap recovery print suites. Increasing recovery levels relate to increasing serving efforts.

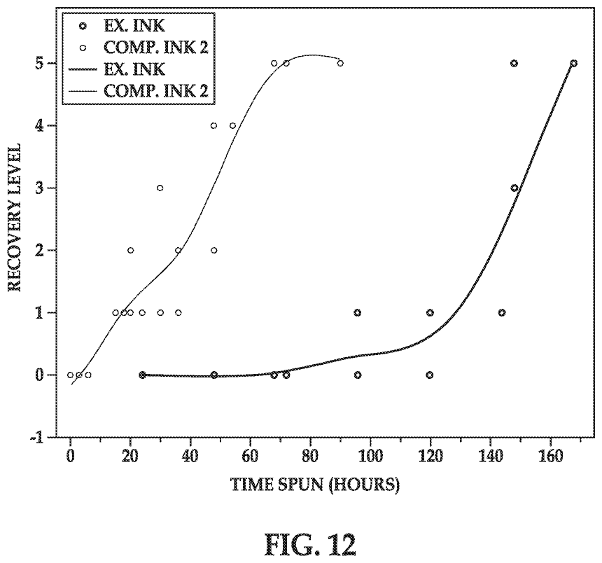

The results of the pigment settling test are shown in FIG. 12. In FIG. 12, the recovery level is shown on the y-axis, and the time (in hours) for which the pens were spun is shown on the x-axis.

As shown in FIG. 12, the recovery levels for Ex. Ink were much less than the recovery levels for Comp. Ink 2 after the same amount of time being spun. As also shown in FIG. 12, Ex. Ink could be spun for much longer than Comp. Ink 2 while having the same or lower recovery level. Further, Ex. Ink produced fewer start of swath print defects than Comp. Ink 2. These results indicate that Ex. Ink had less pigment settling than Comp. Ink 2.

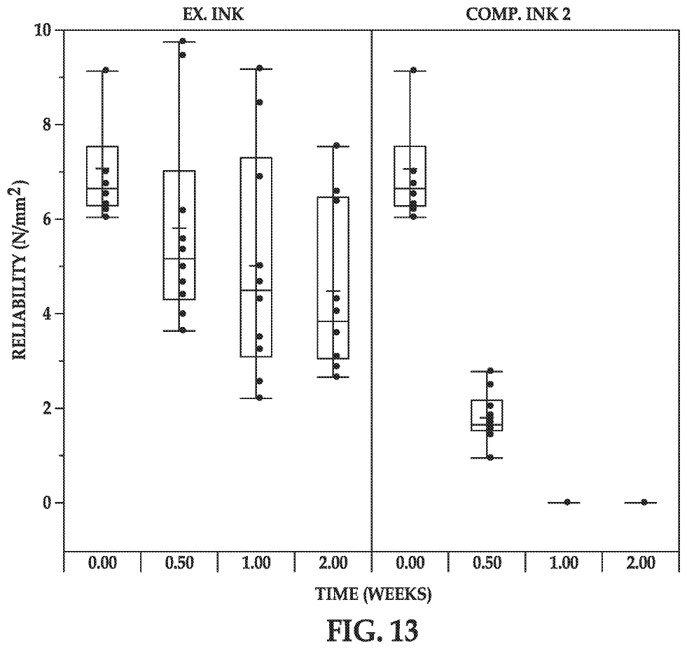

Ex. Ink (from Example 1) and Comp. Ink 2 (from Example 1) were also tested for their respective effects on pen reliability. Pen reliability was assessed as adhesion strength during scrape adhesion testing of an adhesive bead on a polymeric substrate. An adhesive bead is dispensed on a polymeric coupon substrate, cured and sheared off. The force needed to shear the bead off is recorded and normalized per surface area of bead (adhesion strength in N/mm²). This procedure is repeated after soaking the coupon in the respective inks for a fixed time (0.5, 1 and 2 weeks) at 70° C. This test is indicative of the effect that the respective inks have on the pen used to print the ink. The results of the reliability test are shown in FIG. 13. In FIG. 13, reliability (in N/mm² as the unit for adhesion strength) is shown on the y-axis, and the time (in weeks) is shown on the x-axis. As shown in FIG. 13, Comp. Ink 2 degraded the coupon faster than Ex. Ink. The results for Comp. Ink 2 also show that the comparative ink degraded the coupon to a further extent (more severely) than Ex. Ink. These results indicate that the lower conductivity Ex. Ink improved pen reliability when compared to the higher conductivity Comp. Ink 2.

Ex. Ink (from Example 1) and Comp. Ink 1 (from Example 1) were also tested for caking. Caking of the ink on the die of the printer causes missing nozzles. The caking test was performed in HP Ink Tank Wireless 415 printers using regular print suites. The dies were visually observed for any permanent ink deposits (caking) at increasing printing levels with a constant servicing level. Increasing missing nozzles relates to cake (i.e., a permanent ink deposit) on the die. Ex. Ink did not produce any caking on the die. Comp. Ink 1 did produce caking on the die.

It is to be understood that the ranges provided herein include the stated range and any value or sub-range within the stated range, as if such values or sub-ranges were explicitly recited. For example, from about 50 μS/cm to about 300 μS/cm should be interpreted to include not only the explicitly recited limits of from about 50 μS/cm to about 300 μS/cm, but also to include individual values, such as about 95 μS/cm, about 136.7 μS/cm, about 179 μS/cm, about 223.97 μS/cm, etc., and sub-ranges, such as from about 71.13 μS/cm to about 210 μS/cm, from about 100.25 μS/cm to about 241 μS/cm, from about 143.1 μS/cm to about 280.98 μS/cm, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A continuous ink supply system, comprising:
an ink supply reservoir;
a conduit fluidly connected to the ink supply reservoir; and
a low-conductivity ink contained in the ink supply reservoir, the low-conductivity ink including:
a self-dispersed carbon black pigment;
a non-ionic surfactant;
a co-solvent; and
a balance of water;
wherein the low-conductivity ink has a conductivity of 400 μS/cm or less.

2. The continuous ink supply system as defined in claim 1 wherein the low-conductivity ink is devoid of a binder.

3. The continuous ink supply system as defined in claim 1 wherein the low-conductivity ink has a conductivity of about 148 μS/cm.

4. The continuous ink supply system as defined in claim 1 wherein low-conductivity ink further comprises an additive selected from the group consisting of a chelating agent, an antimicrobial agent, an anti-kogation agent, an anti-decel agent, a pH adjuster, a buffering agent, and a combination thereof.

5. The continuous ink supply system as defined in claim 1 wherein the self-dispersed carbon black pigment is present in the low-conductivity ink in an amount ranging from about 2.5 wt % active to about 10 wt % active, based on a total weight of the low-conductivity ink.

6. The continuous ink supply system as defined in claim 1 wherein the non-ionic surfactant is present in the low-conductivity ink in an amount ranging from about 0.01 wt % active to about 0.5 wt % active, based on a total weight of the low-conductivity ink.

7. The continuous ink supply system as defined in claim 1, wherein the co-solvent is present in the low-conductivity ink in an amount ranging from about 5 wt % to about 35 wt %, based on a total weight of the low-conductivity ink.

8. The continuous ink supply system as defined in claim 1 wherein the self-dispersed carbon black pigment has an average particle size ranging from about 115 nm to about 145 nm.

9. The continuous ink supply system as defined in claim 1 wherein the low-conductivity ink has a viscosity ranging from about 2.4 cP to about 2.9 cP at 25° C.

10. A printing system, comprising:
a printer including a plurality of printheads;
a continuous ink supply system including:
an ink supply reservoir; and
a conduit fluidly connecting the ink supply reservoir to the plurality of printheads; and
a low-conductivity ink contained in the ink supply reservoir, the low-conductivity ink including:
a self-dispersed carbon black pigment;
a non-ionic surfactant;
a co-solvent; and
a balance of water;
wherein the low-conductivity ink has a conductivity of 400 μS/cm or less.

11. The printing system as defined in claim 10 wherein the plurality of printheads are thermal inkjet printheads or piezoelectric printheads.

12. The printing system as defined in claim 10 wherein the low-conductivity ink has a conductivity of about 148 μS/cm.

13. The printing system as defined in claim 10 wherein the low-conductivity ink is devoid of a binder.

14. A binder-less, low-conductivity inkjet ink, comprising:
a self-dispersed carbon black pigment;
a non-ionic surfactant;
a co-solvent; and
a balance of water;
wherein the binder-less, low-conductivity inkjet ink has a conductivity of 400 μS/cm or less.

15. The binder-less, low-conductivity inkjet ink as defined in claim 14, further comprising an additive selected from the group consisting of a chelating agent, an antimicrobial agent, an anti-kogation agent, an anti-decel agent, a pH adjuster, a buffering agent, and a combination thereof.
